(19) United States
(12) Patent Application Publication
(10) Pub. No.: US 2026/0001731 A1
(43) Pub. Date: Jan. 1, 2026

(54) Rotary Valve and Process Plant Having a Rotary Valve

(71) Applicant: Glatt Maschinen- und Apparatebau AG, Pratteln (CH)

(72) Inventors: Jochen Thies, Lörrach (DE); Heinz Pritzke, Braunsdorf (DE); Thomas Hofmaier, Lörrach (DE); Markus Krumme, Allschwil (CH); Reinhard Nowak, Lörrach (DE)

(21) Appl. No.: 18/868,257

(22) PCT Filed: May 17, 2023
(86) PCT No.: PCT/EP2023/063249

§ 371 Date: Nov. 22, 2024

(30) Foreign Application Priority Data
May 23, 2022 (DE) 10 2022 112 948.9

(51) Int. Cl. B65G 53/46

(52) U.S. Cl. CPC B65G 53/4633; B65G 2201/042

(57) ABSTRACT

A rotary valve for dosing, introducing and/or discharging granules and a process plant for pulsation-free dosing, introducing and/or discharging granules, including a granulator and a rotary valve connected to a discharge of the granulator. The rotary valve includes a housing wherein an interior space is formed which is confined by a housing wall with a cylindrical inner wall surface. The housing has an introducing unit in an introducing zone that opens with an inlet opening into the interior space and, in a discharge zone spaced apart in relation to the introducing zone in the peripheral direction of the center axis, a discharge unit including an outlet opening likewise opening into the interior space. The housing wall extends over the outlet opening and, in the region of the outlet opening, includes a screen wall section designed as a screen.

### CROSS-REFERENCE TO RELATED APPLICATIONS

This application is the United States national phase of International Patent Application No. PCT/EP2023/063249 filed May 17, 2023, and claims priority to German Patent Application No. 10 2022 112 948.9 filed May 23, 2022, the disclosures of which are hereby incorporated by reference in their entireties.

### BACKGROUND

### Field

The invention relates to a rotary valve for dosing, introducing and/or discharging granules, having a housing in which an interior space is formed, which is confined by a housing wall with a cylindrical inner wall surface and comprises a central centre axis, wherein the housing has an introducing unit in an introducing zone that opens with an inlet opening into the interior space and, in a discharge zone spaced apart in relation to the introducing zone in the peripheral direction of the centre axis, a discharge unit comprising an outlet opening likewise opening into the interior space, with a bucket wheel arranged in the interior space and rotatable about an axis of rotation coinciding with the centre axis while executing a conveying rotary movement, which comprises bucket wheel scoops extending radially from the centre axis to the inner wall surface, wherein a bucket wheel compartment for receiving granules is formed between each two consecutive bucket wheel scoops and moves during the conveying rotary movement from the introducing zone to the discharge zone.

Furthermore, the invention relates to a process plant for pulsation-free dosing, introducing and/or discharging granules, comprising a granulator and a rotary valve connected to a discharge of the granulator.

### Description of Related Art

In tablet production, particularly in the continuous production of solid dosage forms, also known as solida, rotary valves are used for the process step of dosing, introducing and/or discharging granules.

WO 2020/156750 A1 discloses a rotary valve of this type. The rotary valve comprises a housing having at least one introducing unit and at least one discharge unit, in which a driven bucket wheel is arranged, which comprises a plurality of bucket wheel scoops that extend essentially radially and define the bucket wheel compartments in the peripheral direction, and wherein at least the bucket wheel scoops are formed from an elastically compliant material and two adjacent bucket wheel scoops are each connected to one another in the region of their radially inner ends by means of a bucket bottom in each case so that the bucket bottoms of the bucket wheel are formed by elastically yielding membranes, which are each connected to two neighboring bucket wheel scoops in the area of the radially inner ends of the latter and each extend over a cavity arranged on the radially inner side of a respective membrane.

DE 10 2004 044 217 B4 also discloses a rotary valve. The rotary valve comprises a housing that has an interior space defined by a substantially cylindrical inner wall, an upper inlet opening into the interior space, a lower outlet opening out of the interior space, a centre axis and end faces defining the interior space, with housing covers closing the end faces, which are attached to the housing and which comprise bearing openings concentrically to the centre axis, with a bucket wheel which is arranged concentrically to the centre axis, which is rotatably mounted passing through the bearing openings, and which comprises scoops which extend radially to the centre axis into the vicinity of the inner wall and in the direction of the centre axis into the vicinity of the housing cover, each housing cover comprising at least one groove-like recess which is open towards the interior space and extends from the region of the respective bearing opening radially to the centre axis beyond the scoops into the outlet.

### SUMMARY

A disadvantage of the rotary valves known from the prior art is that they are not suitable for carrying out further necessary process steps in tablet production.

The task of the invention is therefore to provide a rotary valve that overcomes the disadvantages of the prior art and is suitable for carrying out further process steps for tablet production in addition to dosing, introducing and discharging granules.

This task is realized in a rotary valve of the type mentioned above by the fact that the housing wall extends over the outlet opening and, in the region of the outlet opening, comprises a screen wall section designed as a screen. The screen allows the granules to be further processed by crushing and sieving them. The advantage of this is that the rotary valve not only meters, introduces and discharges granules, but also screens and crushes them. Furthermore, screening and crushing the granules makes it possible to improve the metering of small mass flows in particular through the rotary valve.

The screen can be designed in a wide variety of ways. For example, as a wire screen or also as a metal insert, expediently as a sheet metal or steel insert.

According to an advantageous embodiment of the rotary valve the screen (23) can be removed and/or replaced. By exchanging the screen, it is possible to insert screens with different mesh sizes into the rotary valve and thus adjust the particle size of the granules to the process requirements. The screen can also be replaced when it is worn. In addition, the option of removing the screen also makes it easy to clean the screen. If a screen is not needed, it can be left out or, for example, a simple frame can be used.

According to a further embodiment of the rotary valve the inner wall surface is at least partially designed as a sealing surface and/or each bucket wheel scoop comprises a scoop surface that is at least partially designed as a sealing surface. Due to the design of the sealing surfaces, pressure differences between the entry side and the discharge side can be effectively separated from each other.

According to additional embodiment of the rotary valve the rotary valve comprises a drive unit that causes the bucket wheel to perform the conveying rotary movement. Expediently the drive unit is suitable for performing a uniform conveying rotary movement or an alternating conveying rotary movement. In this case the alternating conveying rotary movement comprises a rotation of the bucket wheel in the conveying direction (forward movement) and a subsequent rotation of the bucket wheel in the opposite direction to the conveying direction (backward movement), the rotation of the bucket wheel in the conveying direction being greater than the rotation of the bucket wheel in the opposite direction to the conveying direction. At the same time, the conveying rotary movement should always be seen in relation to a screen length. Preferably the bucket wheel rotates in the conveying direction through an angle a and then rotates in the opposite direction through an angle b, angle a being greater than angle b. This improves the screening and crushing of the granules and ensures improved emptying of the bucket wheel compartment.

Preferably the angle a comprises an angular dimension between 5° and 30° and the angle b comprises an angular dimension between 5° and 25°, the angle a expediently comprising an angular dimension of 10° and the angle b comprising an angular dimension of 5°.

Furthermore, the bucket wheel scoops are designed in such a way that the bucket wheel compartments form a multi-start helical space. A uniform mass flow is achieved by the multi-start helical spaces of the bucket wheel compartments through the adequate superposition of the bucket wheel compartments above the screen, thus improving the dosing of the granules through the rotary valve. The wider the bucket wheel is designed, the more advantageous a multi-start helical space of the bucket wheel compartment is for a uniform mass flow.

Preferably the introducing zone and the discharge zone are arranged asymmetrically to one another in the housing. The asymmetrical arrangement of the introducing zone and the discharge zone in relation to each other ensures optimized filling of the bucket wheel compartments, which preferably comprise a multi-start helical arrangement.

According to a further embodiment of the rotary valve the bucket wheel compartments comprise an asymmetrically designed cross-sectional area. The asymmetrical cross-sectional area of the bucket wheel compartment has a positive effect on the one hand on the optimized filling of the bucket wheel compartment on the feed side and on the other hand on the emptying of the bucket wheel compartment on the discharge side.

According to an additional embodiment of the rotary valve the rotary valve comprises at least one nozzle arrangement for compressed-air-controlled emptying of the bucket wheel compartments. The nozzle arrangement improves the emptying of the bucket wheel compartment. In this regard, the nozzle arrangement is designed to enable the angle-controlled injection of compressed air in the area of the screen wall section.

This task is realized in a process plant of the type mentioned above by the fact that the rotary valve is designed as a rotary valve for dosing, introducing and/or discharging granules, having a housing in which an interior space is formed, which is confined by a housing wall with a cylindrical inner wall surface and comprises a central centre axis, wherein the housing has an introducing unit in an introducing zone that opens with an inlet opening into the interior space and, in a discharge zone spaced apart in relation to the introducing zone in the peripheral direction of the centre axis, a discharge unit comprising an outlet opening likewise opening into the interior space, with a bucket wheel arranged in the interior space and rotatable about an axis of rotation coinciding with the centre axis while executing a conveying rotary movement, which comprises bucket wheel scoops extending radially from the centre axis to the inner wall surface, wherein a bucket wheel compartment for receiving granules is formed between each two consecutive bucket wheel scoops and moves during the conveying rotary movement from the introducing zone to the discharge zone, wherein the housing wall extends over the outlet opening and, in the region of the outlet opening, comprises a screen wall section designed as a screen. Such a process plant is advantageously suited to produce the granules required in tablet production, in particular in the continuous production of solid dosage forms, and to dose them in accordance with the process requirements for further processing in the process.

The granulator is advantageously designed as a fluidizing apparatus, expediently as a fluidized bed apparatus or a spouted bed apparatus.

According to a preferred embodiment of the process plant the rotary valve comprises a drive unit that causes the bucket wheel to perform the conveying rotary movement. In this regard the drive unit is suitable for performing a uniform conveying rotary movement or an alternating conveying rotary movement. Furthermore, the alternating conveying rotary movement comprises a rotation of the bucket wheel in the conveying direction and a subsequent rotation of the bucket wheel in the opposite direction to the conveying direction, the rotation of the bucket wheel in the conveying direction being greater than the rotation of the bucket wheel in the opposite direction to the conveying direction. Referring to this the bucket wheel rotates in the conveying direction through an angle a and then rotates in the opposite direction through an angle b, angle a being greater than angle b. In a very preferred embodiment the angle a comprises an angular dimension between 5° and 30° and the angle b comprises an angular dimension between 5° and 25°, the angle a expediently comprising an angular dimension of 10° and the angle b comprising an angular dimension of 5°.

### BRIEF DESCRIPTION OF THE DRAWINGS

The terms FIG., FIGS., Figure, and Figures are used interchangeably in the specification to refer to the corresponding figures in the drawings.

The invention is explained in more detail below, with reference to the accompanying drawings, in which

FIG. 1 a process plant with a rotary valve downstream of a granulator,

FIG. 2 a plan view of a first embodiment of the rotary valve with a sectional plane A-A,

FIG. 3 a sectional view of the first rotary valve embodiment shown in FIG. 1 through the sectional plane A-A,

FIG. 4 a radial view of a bucket wheel arranged in the first embodiment of the rotary valve,

FIG. 5 a plan view of the rotary valve with a sectional plane B-B,

FIG. 6 a half-section of the second embodiment of the rotary valve shown in FIG. 5, through the sectional plane B-B, and

FIG. 7 a radial view of a bucket wheel arranged in the second embodiment of the rotary valve.

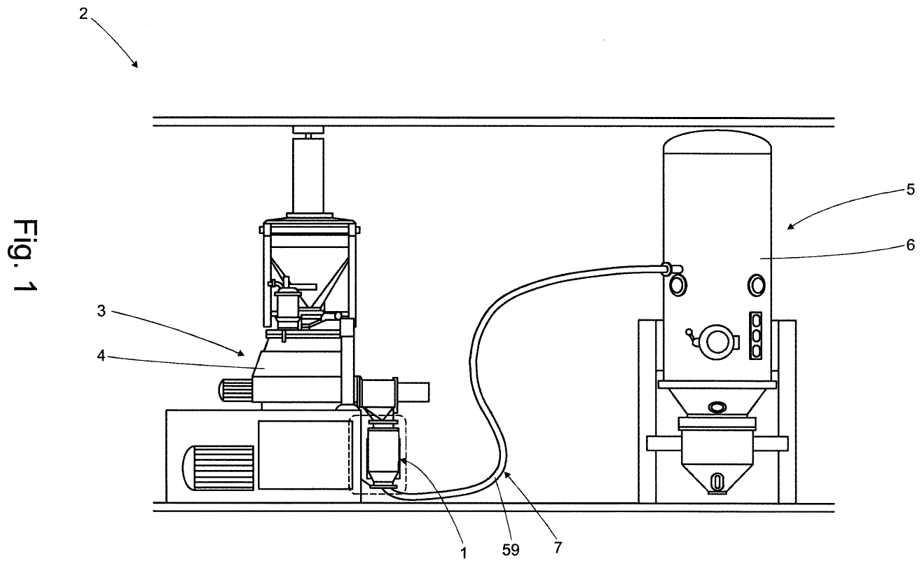

### DETAILED DESCRIPTION

Unless otherwise specified, the following description refers to all the embodiments of a rotary valve 1 for dosing, introducing and/or discharging granules and a process plant 2 comprising the rotary valve 1.

The process plant 2 comprises a rotary valve 1 downstream of a granulator 3. The granulator 3 is expediently designed as a high-shear granulator 4, as a roller compactor or as a fluidizing apparatus designed in particular as a fluidized bed apparatus or spouted bed apparatus. The rotary valve 1 is arranged upstream of a dryer 5, in particular a fluidized bed dryer 6, and is connected to the latter by means of a line 7, expediently a flexible hose connection 59. The process plant 2 comprising the rotary valve 1 is suitable for ensuring pulsation-free dosing, introducing and/or discharging of granules into the dryer 5.

The rotary valve 1 comprises a housing 9 with a housing wall 8 and an at least essentially cylindrical interior space 10, wherein the interior space 10 is confined by a cylindrical inner wall surface 11. Furthermore, the interior space 10 comprises a central centre axis 12. The interior space 10 of the housing 9 is open at its end faces 13, 14, the end faces 13, 14 being covered by a housing cover 15, 16 in each case, which are detachably fastened to the housing 9 by means of screws not shown.

An introducing unit 19, which is arranged in an introducing zone 17 and comprises an inlet opening 18, opens into the interior space 10 from above. A discharge unit 22, which is likewise arranged in the interior space 10 and comprises an outlet opening 21, is arranged in a discharge zone 20 that is spaced apart in this respect in the circumferential direction of the centre axis 12.

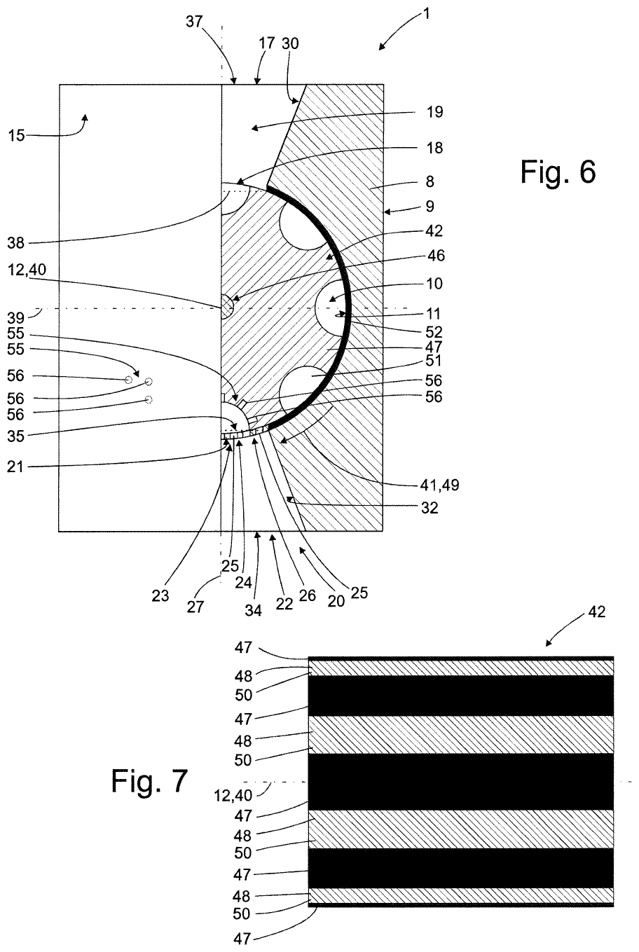

The housing wall 8 extends over the outlet opening 21 and comprises a screen wall section 24 designed as a screen 23 in the area of the outlet opening 21. The screen 23 is expediently removable and/or replaceable. In the first embodiment of the rotary valve 1 shown in FIG. 3, the screen 23 comprises holes 26 that extend radially in the housing wall 8 and are formed as bores 25. In the second embodiment of the rotary valve 1 shown in FIG. 6, the holes 26 in the form of bores 25 run axially to a longitudinal centre axis 27 of the rotary valve 1.

The screen 23 can be designed in a wide variety of ways. For example, as a wire screen or as an insert made of metal, expediently as a sheet metal or steel insert.

By replacing the screen 23, it is possible to insert screens 23 with different mesh sizes into the rotary valve 1 and thus adjust the particle size of the granules to the process requirements. Common mesh sizes are in the range between 0.1 mm and 2 mm, in particular between 1.0 mm and 1.5 mm.

Furthermore, it is also expediently possible for the holes formed as holes 26 to be differently shaped. The bores 25 can, for example, form an angular, round, oval, parallelogram-shaped or similar form. In addition, the screen 23 can also comprise bores 25 of different shapes.

The screen 23 can also be replaced if it is worn. In addition, the option of removing the screen 23 also makes it easy to clean the screen 23. If no screen 23 is required, the screen 23 can be omitted or, for example, a simple frame (not shown) can be used.

Advantageously, rotary valve 1 thus takes over not only the dosing, introducing and discharging of granules, but also the process steps of sieving and crushing the granules. Furthermore, sieving and crushing the granules makes it possible to improve the dosing of small mass flows in particular by means of rotary valve 1.

In the first embodiment of the rotary valve 1 shown in FIG. 3, the introducing zone 17 is arranged on the upper half side 28 of the rotary valve 1 and the discharge zone 20 is arranged on the lower half side 29 of the rotary valve 1. The inner wall surfaces 30, 31 of the introducing unit 19 run parallel to the longitudinal centre axis 27, vertically from a top surface 57 to an bottom surface 58. The inner wall surface 32 of the discharge unit 22 runs obliquely to the longitudinal centre axis 27 from the top surface 57 to the bottom surface 58 of the rotary valve 1, whereas the inner wall surface 33 extends parallel to the longitudinal centre axis 27, perpendicularly from the top surface 57 to the bottom surface 58. Thus, a discharge surface 34 of the discharge unit 22 is smaller than a projected area 35 of the outlet opening 21.

The introducing zone 17 and the discharge zone 20 are arranged at least partially offset to one another over a width 36 of the rotary valve 1. As a result, the introducing zone 17 and the discharge zone 20 are arranged asymmetrically to one another in the housing 9.

In contrast to this, the introducing zone 17 and the discharge zone 20 are arranged vertically one above the other in the centre of the rotary valve 1, as shown in the second embodiment of the rotary valve 1 in FIG. 6. The inner wall surfaces 30, 31 of the introducing unit 19 are conically shaped, converging from the upper surface 57 to the bottom surface 58 of the rotary valve 1. The introducing surface 37 of the introducing unit 19 is thus larger than a projected area 38 of the inlet opening 18. The inner wall surfaces 32, 33 of the discharge unit 22 are conically diverging from the upper surface 57 to the lower surface 58 of the rotary valve 1. Thus, a discharge surface 34 of the discharge unit 22 is larger than a projected area 35 of the outlet opening 21. The introducing unit 19 and the discharge unit 22 are thus designed symmetrically to a mirror axis 39 in the housing 9, just like the introducing zone 17 and the discharge zone 20.

A bucket wheel 42 that can rotate about an axis of rotation 40 that coincides with the centre axis 12, while performing a conveying rotary movement 41, is arranged in the interior space 10. The bucket wheel 42 is interchangeably arranged in the interior space 10. The shaft 46 of the bucket wheel 42, which is driven by a drive unit 43, expediently by a motor 44, preferably by an electric motor or a torque motor 45, passes through bearing openings, which are formed in the housing covers 15, 16 and are not shown, and is rotatably mounted in the bearings, which are mounted in the housing covers 15, 16 and are not shown. Furthermore, the bucket wheel 42 comprises bucket wheel scoops 47 that extend radially from the centre axis 12 towards the inner wall surface 11.

A bucket wheel compartment 48 for receiving granules is formed between each two consecutive bucket wheel scoops 47. The bucket wheel 42 comprises a plurality of bucket wheel compartments 48, preferably between 3 and 25 bucket wheel compartments 48. The bucket wheel compartment 48 moves in the conveying direction 49 from the introducing zone 17 to the discharge zone 20. The asymmetrical arrangement of the introducing zone 17 and the discharge zone 20 relative to one another ensures optimized filling of the cellular chambers 48. Each bucket wheel compartment 48 takes up granules under the introducing unit 19 and at the discharge unit 22 the granules are conveyed through the screen wall section 24 designed as a screen 23. This results in a volumetrically continuous conveying of the granules, expediently at 1 to 100 rpm of the bucket wheel 42. The conveying capacity is determined by the granule content of the bucket wheel compartments 48 and the speed of the bucket wheel 42.

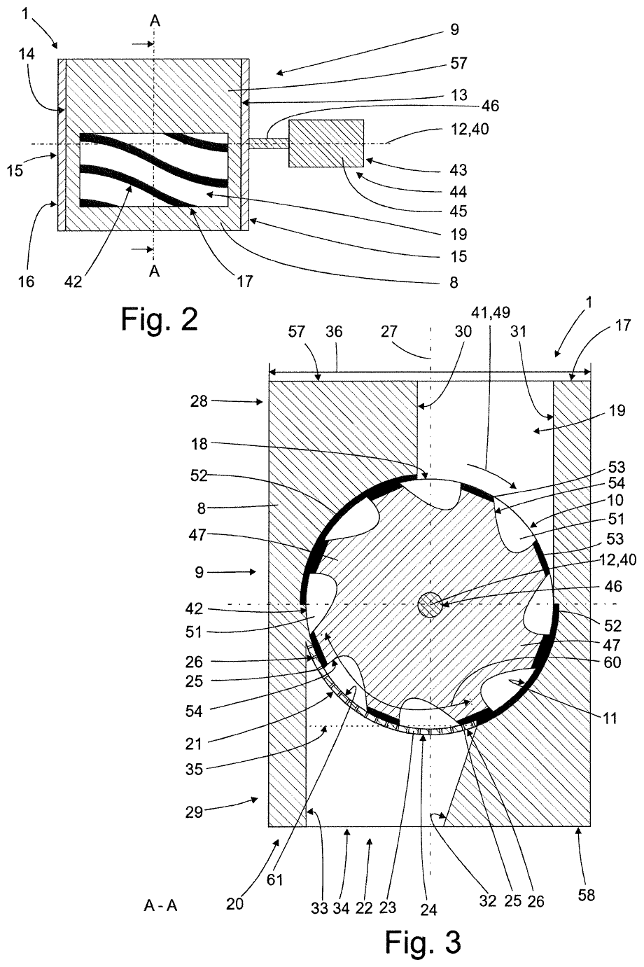

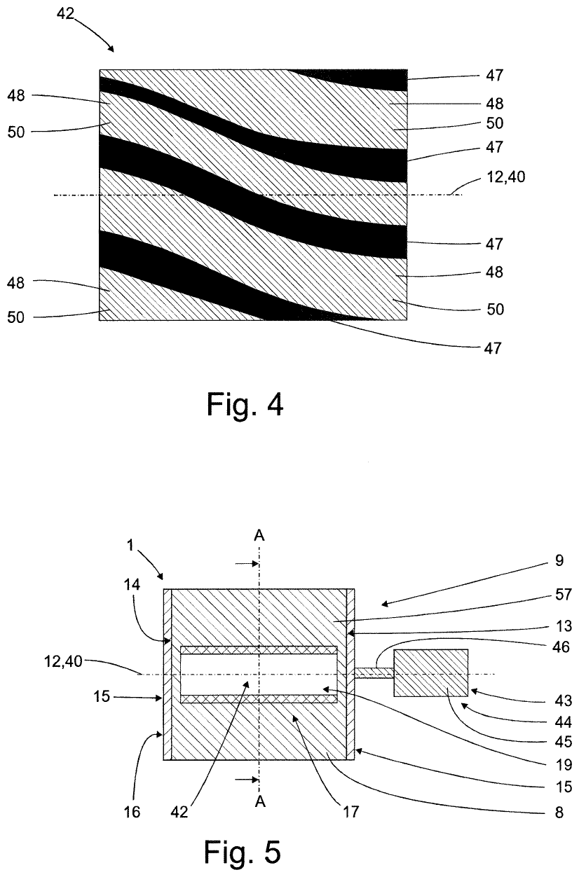

As shown in FIGS. 2 and 4, the bucket wheel scoops 47 of the first embodiment of the bucket wheel 42 are designed such that the bucket wheel compartments 48 form a multi-start helical space 50 in the axial direction of the axis of rotation 40. A uniform mass flow is achieved by the multi-start helical spaces 50 of the bucket wheel compartments 48 by adequate superposition of the bucket wheel compartments 48 over the screen 23, thus improving the dosing of the granules by the rotary valve 1. Expediently, the space 50 comprises an asymmetrically formed cross-sectional area 51. The wider the bucket wheel 42 is formed, the more advantageous a multi-start helical space 50 of the bucket wheel compartment 48 is for a uniform mass flow.

In contrast to the first embodiment of the bucket wheel 42, the bucket wheel scoops 47 of the second embodiment of the bucket wheel 42, shown in FIG. 7, are designed in such a way that the space 50 formed between two consecutive bucket wheel scoops 47 takes the form of a half cylinder. The cross-sectional area 51 of the bucket wheel compartments 48 is thus semicircular, as shown in FIG. 6.

The drive unit 43 is expediently configured to cause a constant conveying rotary movement 41 of the bucket wheel 42. Such a conveying rotary movement 41 is realized in the first embodiment. The arrangement of the bucket wheel compartments 48 during a constant conveying rotary movement 41 is expediently chosen such that at least two bucket wheel compartments 48 are at least partially in contact with the screen 23 at all times during the conveying rotary movement 41. This can suppress a pulsation of the mass flow.

Alternatively, the drive unit 43 is suitable for causing a conveying rotary movement 41, which is expediently designed as an alternating conveying rotary movement 41. Such a conveying rotary movement 41 is realized in the second embodiment. In this case, the alternating conveying rotary movement 41 comprises a rotation of the bucket wheel 42 in the conveying direction 49 (forward movement) and a subsequent rotation of the bucket wheel 42 against the conveying direction 49 (backward movement). In the alternating conveying rotary movement 41, the rotation of the bucket wheel 42 in the conveying direction 49 (forward movement) is preferably greater than the rotation of the bucket wheel 42 against the conveying direction 49 (backward movement). At the same time, the conveying rotary movement 41 should always be seen in relation to a screen length 60. The arrangement of the bucket wheel compartments 48 is also expediently selected for the alternating conveying rotary movement 41 such that at least two bucket wheel compartments 48 are at least partially in contact with the screen 23 at all times during the conveying rotary movement 41. This can suppress a pulsation of the mass flow.

For example, with an alternating conveying rotary movement 41 and a screen length 60 of 60 mm, the forward movement can also be 60 mm and the backward movement 45 mm in absolute value. Other values for the forward and/or backward movement are also possible. Thus, after one cycle, i.e. one forward and one backward movement, the bucket wheel 42 rotates a “net” 15 mm in the conveying direction 49. This avoids that always the same screen surface 61 is used and always the same screen surface 61 is cleaned by the backward movement.

This naturally results in angles, namely an angle a for the forward movement and an angle b for the backward movement. Accordingly, an alternating conveying rotary movement 41 also means, in particular, the rotation of the bucket wheel 42 in the conveying direction 49 by an angle a and then a rotation of the bucket wheel 42 against the conveying direction 49 by an angle b, where the angle a is greater than the angle b. This improves the screening and crushing of the granules and ensures improved emptying of the bucket wheel compartment 48. Preferably, angle a has an angular dimension between 5° and 30° and angle b has an angular dimension between 5° and 25°, with angle a preferably comprising an angular dimension of 10° and angle b an angular dimension of 5°. The angular dimension of the angles a and b is preferably selected so that at least two spaces 50 are at least partially in contact with the screen 23 at all times during the conveying rotary movement. This can suppress a pulsation of the mass flow.

The conveying rotary movement 41 can be determined by selecting the drive unit 43, in particular a constant conveying rotary movement 41 or an alternating conveying rotary movement can be selected. The drive unit can also be designed to effect, on the one hand, the constant conveying rotary movement 41 of the bucket wheel 42 and, on the other hand, the alternating conveying rotary movement 41.

The formation of sealing surfaces 52, 53 makes it possible to effectively separate any pressure differences occurring between the introducing unit 19 and the discharge unit 22 and thus maintain two different pressure levels. In the first embodiment of the rotary valve 1, shown in FIG. 3, the inner wall surface 11 is at least partially formed as a sealing surface 52 and each bucket wheel scoop 47 comprises a scoop surface 54 that is at least partially formed as a sealing surface 53. In the half-section of the second design of the rotary valve 1 shown in FIG. 6, only the inner wall surface 11 comprises the sealing surface 52.

In the second embodiment of the rotary valve 1 shown in FIG. 6, two different options are shown comprising a nozzle arrangement 55 for compressed-air-controlled emptying of the bucket wheel compartments 48.

In the first example, the bucket wheel 42 comprises the nozzle arrangement 55 for emptying each bucket wheel compartment 48 in the form of a plurality of nozzles 56 arranged in the bucket wheel scoop 47.

In a second example, the housing cover 15 comprises the nozzle arrangement 55, in particular in the form of nozzles 56 for emptying each bucket wheel compartment 48. The nozzle arrangement 55 is particularly preferably designed to enable the angle-controlled injection of compressed air in the area of the screen wall section 24. In this case, it is particularly preferred if nozzles 56 are arranged in the housing cover 15, 16 for each bucket wheel compartment 48 arranged simultaneously above the screen wall section 24. If, for example, two bucket wheel compartments 48 are simultaneously above the screen 23, compressed air should be able to be blown into both of them, expediently via nozzles 56.

1. A rotary valve for dosing, introducing and/or discharging granules, comprising: a housing wherein an interior space is formed, which is confined by a housing wall with a cylindrical inner wall surface and comprises a central center axis, wherein the housing has an introducing unit in an introducing zone, that opens with an inlet opening into the interior space and, in a discharge zone spaced apart in relation to the introducing zone in the peripheral direction of the centre axis, a discharge unit comprising an outlet opening likewise opening into the interior space, with a bucket wheel arranged in the interior space and rotatable about an axis of rotation coinciding with the center axis while executing a conveying rotary movement, which comprises bucket wheel scoops extending radially from the center axis to the inner wall surface, wherein a bucket wheel compartment for receiving granules is formed between each two consecutive bucket wheel scoops and moves during the conveying rotary movement from the introducing zone to the discharge zone, wherein the housing wall extends over the outlet opening and, in the region of the outlet opening, comprises a screen wall section designed as a screen.

2. The rotary valve according to claim 1, wherein the screen can be removed and/or replaced.

3. The rotary valve according to claim 1, wherein the inner wall surface is at least partially designed as a sealing surface and/or each bucket wheel scoop comprises a scoop surface that is at least partially designed as a sealing surface.

4. The rotary valve according to claim 1, wherein the rotary valve comprises a drive unit that causes the bucket wheel to perform the conveying rotary movement.

5. The rotary valve according to claim 4, wherein the drive unit is suitable for performing a uniform conveying rotary movement or an alternating conveying rotary movement.

6. The rotary valve according to claim 5, wherein the alternating conveying rotary movement comprises a rotation of the bucket wheel in the conveying direction and a subsequent rotation of the bucket wheel in the opposite direction to the conveying direction, the rotation of the bucket wheel in the conveying direction being greater than the rotation of the bucket wheel in the opposite direction to the conveying direction.

7. The rotary valve according to claim 6, wherein the bucket wheel rotates in the conveying direction through an angle a and then rotates in the opposite direction through an angle b, angle a being greater than angle b.

8. The rotary valve according to claim 7, wherein the angle a comprises an angular dimension between 5° and 30° and the angle b comprises an angular dimension between 5° and 25°, the angle a expediently comprising an angular dimension of 10° and the angle b comprising an angular dimension of 5°.

9. The rotary valve according to claim 1, wherein in the bucket wheel scoops are designed in such a way that the bucket wheel compartments form a multi-start helical space.

10. The rotary valve according to claim 1, wherein the introducing zone and the discharge zone are arranged asymmetrically to one another in the housing.

11. The rotary valve according to claim 1, wherein the bucket wheel compartments comprise an asymmetrically designed cross-sectional area.

12. The rotary valve according to claim 1, wherein the rotary valve comprises at least one nozzle arrangement for compressed-air-controlled emptying of the bucket wheel compartments.

13. The rotary valve according to claim 12, wherein the bucket wheel comprises the nozzle arrangement for emptying each bucket wheel compartment and/or a housing cover comprises the nozzle arrangement for emptying each bucket wheel compartment.

14. A process plant for pulsation-free dosing, introducing and/or discharging granules, comprising: a granulator and a rotary valve connected to a discharge of the granulator, wherein the rotary valve is designed as a rotary valve for dosing, introducing and/or discharging granules, the rotary vale comprising a housing wherein an interior space is formed, which is confined by a housing well with a cylindrical inner wall surface and comprises a central center axis, wherein the housing has an introducing unit in a introducing zone that opens with an inlet opening into the interior space and, in a discharge zone spaced apart in relation to the introducing zone in the peripheral direction of the center axis, a discharge unit comprising an outlet opening likewise opening into the interior space, with a bucket wheel arranged in the interior space and rotatable about an axis of rotation coinciding with the center axis while executing a conveying rotary movement, which comprises bucket wheel scoops extending radially from the center axis to the inner wall surface, wherein a bucket wheel compartment for receiving granules is formed between each two consecutive bucket wheel scoops and moves during the conveying rotary movement from the introducing zone to the discharge zone, wherein the housing wall extends over the outlet opening and, in the region of the outlet opening, comprises a screen wall section designed as a screen.

15. The process plant according to claim 14, wherein the granulator is designed as a fluidizing apparatus or a spouted bed apparatus.

16. The process plant according to claim 14, wherein the rotary valve comprises a drive unit that causes the bucket wheel to perform the conveying rotary movement.

17. The process plant according to claim 16, wherein the drive unit is suitable for performing a uniform conveying rotary movement or an alternating conveying rotary movement.

18. The process plant according to claim 17, wherein the alternating conveying rotary movement comprises a rotation of the bucket wheel in the conveying direction and a subsequent rotation of the bucket wheel in the opposite direction to the conveying direction, the rotation of the bucket wheel in the conveying direction being greater than the rotation of the bucket wheel in the opposite direction to the conveying direction.

19. The process plant according to claim 18, wherein the bucket wheel rotates in the conveying direction through an angle a and then rotates in the opposite direction through an angle b, angle a being greater than angle b.

20. The process plant according to claim 19, wherein the angle a comprises an angular dimension between 5° and 30° and the angle b comprises an angular dimension between 5° and 25°, the angle a expediently comprising an angular dimension of 10° and the angle b comprising an angular dimension of 5°.
